(19) United States
(12) Patent Application Publication
(10) Pub. No.: US 2024/0037651 A1
(43) Pub. Date: Feb. 1, 2024

(54) CRYPTOGRAPHIC LENDING ASSET TRANSACTION INTELLIGENT NEGOTIATION ASSISTANT SYSTEM AND METHOD THEREOF

(71) Applicant: Celligence International LLC, (US)

(72) Inventors: Pavan AGARWAL, DORADO (PR); Gabriel Albors SANCHEZ, SAN JUAN (PR); Jonathan Ortiz RIVERA, SAN JUAN (PR)

(73) Assignee: Celligence International LLC, Guaynabo (PR)

(21) Appl. No.: 18/228,605

(22) Filed: Jul. 31, 2023

Related U.S. Application Data
(63) Continuation-in-part of application No. 18/227,294, filed on Jul. 27, 2023.
(60) Provisional application No. 63/428,656, filed on Nov. 29, 2022.
(60) Provisional application No. 63/392,756, filed on Jul. 27, 2022.

(51) Int. Cl. G06Q 40/03; G06Q 30/0601

(52) U.S. Cl. CPC G06Q 40/03; G06Q 30/0631; G06Q 2220/00

(57) ABSTRACT

Methods and processes can include negotiation assistance to the borrower in the context of attempting to secure a lending product offered by a lender within a blockchain environment. In some embodiments, the system may receive borrower input within a conversation interface of an application and convert the input to identify borrower information. Further, the system may apply a first machine-learning model to the borrower input to determine at least one borrower objective. Finally, the system may generate a lending product recommendation including an explanation for the lending product determination.

### RELATED APPLICATIONS

This application is a continuation-in-part of Non-Provisional application Ser. No. 18/227,294, filed on Jul. 27, 2023, entitled “Cryptographic Asset Verification And Lending Transaction System and Method Thereof”, which claims the benefit of U.S. Provisional Application No. 63/428,656 filed on Nov. 29, 2022, and U.S. Provisional Application No. 63/392,756 filed on Jul. 27, 2022. The contents of the above-referenced applications are incorporated herein by reference in their entirety.

### TECHNICAL FIELD

The present disclosure generally relates to distributed ledger computer systems. More particularly, the present disclosure relates to computer systems and processes for facilitating negotiation of lending instruments issued by lenders using blockchain technology.

### SUMMARY

In accordance with one or more embodiments, various features and functionality can be provided to enable or otherwise facilitate transactions related to evaluating, advising, and negotiating lending offers used to acquire real-estate via an exchange of natural language commands in a conversation interface of an application. The application may be a real-estate transaction application.

In some embodiments, the system for transferring digital assets via an exchange of natural language commands in a conversation interface of a real-estate transaction application may include establishing, by a processor, a first real-estate transaction application in a data store connected to the processor. Next, the system may include storing login information for the first real-estate transaction application.

In some embodiments, the system may receive borrower input within a conversation interface of an application and convert the input to identify borrower information. Further, the system may apply a first machine-learning model to the borrower input to determine at least one borrower objective. Finally, the system may generate a lending product recommendation including an explanation for the lending product determination.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example system for assisting a borrower in negotiating with a lender during digital lending products negotiation, according to an implementation of the disclosure.

FIG. 2 illustrates lending product recommendation server of the example system illustrated in FIG. 1, according to an implementation of the disclosure.

FIG. 3 is an example system for assisting borrower in negotiating digital lending assets in the blockchain context, according to an implementation of the disclosure.

FIG. 4 is an example process for generating lending product recommendations, according to an implementation of the disclosure.

FIG. 5 illustrates an example computing system that may be used in implementing various features of embodiments of the disclosed technology.

Described herein are systems and methods for assisting borrower in negotiating digital lending assets using a conversation interface. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

Having negotiation skills is incredibly beneficial in various aspects of life, both personally and professionally. Having negotiation skills is advantageous and enables effective handing of conflicts and disagreements. Finding mutually acceptable solutions can help maintain positive relationships and avoid unnecessary confrontations. Negotiation involves active listening, empathy, and clear communication. A skilled negotiator seeks to create win-win outcomes where both parties benefit from the agreement. This fosters a positive reputation and encourages future cooperation.

Whether negotiating a business contract or a purchase, having negotiation skills allows to secure more favorable terms and conditions, ultimately saving you money and resources. Having high negotiation skills encourages empathy and understanding of others' needs and interests. This fosters a more harmonious and cooperative environment in personal and professional relationships. Knowing how to negotiate effectively can reduce stress and anxiety in challenging situations. Overall, negotiation skills are an essential toolset that can positively impact various aspects of your life, from resolving conflicts and making better deals to improving communication and building stronger relationships.

However, despite clear benefits, not everyone is or even can become an effective negotiator. Indeed, a large gap in skillset between negotiators in their respective negotiation skills is large. Some negotiators are highly skilled, and others are not. This disparity is especially relevant when a consumer is negotiating the terms of a business contract or a purchase. For example, a lender or another financial services provider will be far more equipped to negotiate than an inexperienced borrower. Presently, no automated or semi-automated tools exist to help consumers before, during, and after a negotiation.

In accordance with various embodiments, a system for enabling negotiation assistance to the borrower with a lender issuing lending product a distributed ledger network is disclosed. On the distributed ledger system, smart contracts can be created and recorded to memorialize these real-estate agreements, record seller information, record owner information, record contingency information (e.g., financing contingency), record property information including purchase price, lender and the type of preapproval (e.g., guaranteed preapproval), and/or record closing or satisfaction of the agreement.

As described earlier, prior to entering into a real-estate agreement, a buyer must secure a guaranteed preapproval from a lender. In one embodiment, a lending entity may approve prospective borrowers based on creditworthiness or other factors as may be desirable. In other embodiments, borrowers are selected according to specified criteria. For example, the lending entity may use criteria for selecting borrowers similar to the criteria currently in use for traditional financing operations. Similarly, the lending entity may consider loan-to-value ratio, debt-to-income ratio, credit score, or other factors relevant to the loan risk. In other words, potential loans may be analyzed and considered in a manner similar to that of a conventional lending operation. Once the lender approves the borrower's request, the lender issues the guaranteed approval as a cryptographic token. Within the context of blockchain technology, a cryptographic token (a crypto token or token) generally refers to a unit of value for a programmable asset that is managed by a smart contract and an underlying distributed ledger. Tokens are the primary means of transferring and storing value on a blockchain network—most often Ethereum. Tokens can also be designed to either be fungible or non-fungible (non-fungible tokens are known as “NFTs”), depending on a network's specific needs.

The guaranteed preapproval issued by the lender as an NFT will be linked to the borrower. Furthermore, the smart contract (or a smart subcontract, and or any combination of these components) used to manage the guaranteed preapproval token may be initialized to memorialize the details, rules, conditions, and other such information associated with the issuance of the guaranteed preapproval. For example, the conditions under which the lender has the ability to revoke the guaranteed preapproval may be embedded into the smart contract. In various embodiments, the guaranteed preapproval can be tracked by a digital wallet. Additionally, all guaranteed preapprovals issued by a particular lender will have the same conditions. Thus, by virtue of all guaranteed preapprovals having the same conditions allows for them to be exchangeable, as will be described in detail herein.

Next, the buyer may use the guaranteed preapproval token to make offers to purchase real-estate from sellers. Upon a seller accepting buyer's offer, the buyer may enter into a real-estate agreement with the seller to buy the property backed by the lender (i.e., by virtue of the guaranteed preapproval). Again, the smart contract record associated with the token will reflect the details of the real-estate agreement between buyer and seller, e.g., the agreed-upon purchase price, the property information, and so on. Additionally, digital wallet identification(s) for lender, borrower (i.e., buyer), and/or seller may be included in the smart agreement. Notably, the execution of the buy-sell agreement may cause a generation of a separate digital representation of the agreement, i.e., an agreement token. This agreement token may be linked to the buyer and buyer's assigned guaranteed preapproval token.

This representative method includes, in any order and in any combination with any of the above or below disclosed features and options: receiving a transaction confirmation indicative of an accepted offer or an agreement to purchase real-estate property by a buyer from a seller based on a guaranteed preapproval from a lender, determining a unique buyer identification code, receiving a validated guaranteed preapproval token associated with the buyer identification code, determining a unique guaranteed preapproval token identification code, generating an agreement token (or a cryptographic digital asset associated with the agreement), the agreement token including a unique agreement identification code (e.g., a key and cryptographic token), linking the cryptographic digital lending asset with the unique buyer identification code and the guaranteed preapproval token identification code, and transmitting to a distributed blockchain ledger (e.g., Bitcoin, Ethereum, Litecoin, etc.), the unique agreement identification code linked with the unique buyer code, and guaranteed preapproval token identification code for recordation on a transaction block.

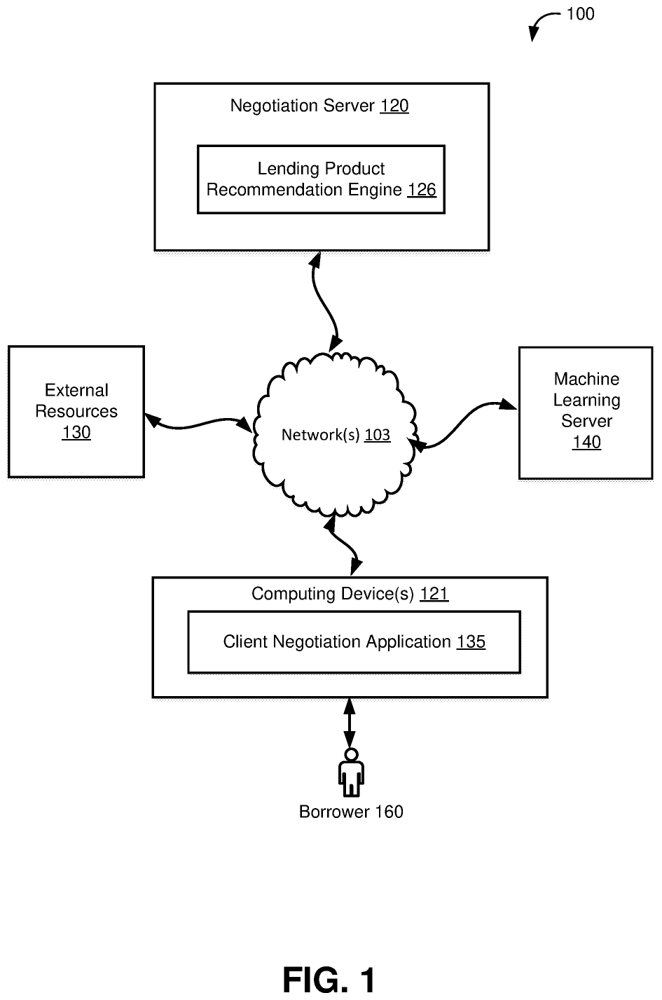

FIG. 1 illustrates exemplary system for providing negotiation assistance to the borrower in the context of attempting to secure a lending product offered by a lender within a blockchain environment 100, in accordance with the embodiments disclosed herein. In some embodiments, negotiation server 120 may include a processor, a memory, and network communication capabilities. In some embodiments, negotiation server 120 may be a hardware server. In some implementation, negotiation server 120 may be provided in a virtualized environment, e.g., negotiation server 120 may be a virtual machine that is executed on a hardware server that may include one or more other virtual machines. Negotiation server 120 may be communicatively coupled to network 103. In some embodiments, negotiation server 120 may transmit and receive information to and from one or more of client computing devices 104, machine learning server 140, external resources 130, and/or other servers via network 103.

In some embodiments, as alluded to above, negotiation server 120 may include a distributed lending product recommendation engine 126 and a corresponding client lending product recommendation application 135 running on one or more client computing devices 104.

In some embodiments, users of lending product recommendation system 100 (e.g., business owners) may access the lending product recommendation engine 126 via client computing device(s) 104. In some embodiments, the various below-described components of FIG. 1 may be used to initiate lending product recommendation application 135 within client computing device 121. In some embodiments, lending product recommendation application 135 may be configured to obtain information related to the business entity entered by user 160 and display lending product recommendations determined by lending product recommendation engine 126. For example, lending product recommendation application 135 may be configured to allow users to enter business name, business type, business activities, and/or other similar information. In some embodiments, business owners may be required to provide various information related to their business and operations via one or more follow-up questions based on the information provided, as described in further detail below.

In some embodiments, machine learning server 140 and/or other components of lead distribution system 100 may be configured to use machine learning, e.g., use a machine learning model that utilizes machine learning to determine business classification and a corresponding insurance carrier classification. In some embodiments, machine learning may be used to determine a likelihood of an insurable incident occurrence based on the business information and business classification, as described in further detail below. In some embodiments, machine learning server 140 may include one or more processors and memory and network communication capabilities. In some embodiments, machine learning server 140 may be a hardware server connected to network 103, using wired connections, such as Ethernet, coaxial cable, fiber-optic cable, etc., or wireless connections, such as Wi-Fi, Bluetooth, or other wireless technology. In some embodiments, machine learning server 140 may transmit data between one or more of leads processing server 130, client computing device 121, external resources 130, and/or other components via network 103.

In some embodiments, external resources 130 may comprise one or more of carrier platforms provided by one or more external insurance agencies or systems. In some embodiments, external resources 130 may comprise one or more underwriting platforms used by one or more insurance agencies or systems. In some embodiments, submission platforms may include one or more servers, processors, and/or databases that can store business classification information, insurance product information, historic claim information, and other such information provided by one or more external systems resources 130. For example, insurance product information may be used by lending product recommendation engine 126 when determining insurance recommendations, as will be further described in detail below.

In some embodiments, lending product recommendation engine 126 may communicate and interface with a framework implemented by external resources 130 using an application program interface (API) that provides a set of predefined protocols and other tools to enable the communication. For example, the API can be used to communicate particular data from an insurance carrier used to connect to and synchronize with lending product recommendation engine 126.

In some embodiments, client computing device 121 may include a variety of electronic computing devices, such as, for example, a smartphone, tablet, laptop, computer, wearable device, television, virtual reality device, augmented reality device, displays, connected home device, Internet of Things (IOT) device, an enhanced general packet radio service (EGPRS) mobile phone, a media player, a navigation device, a game console, a television, a remote control, or a combination of any two or more of these data processing devices, and/or other devices. In some embodiments, client computing device 121 may present content to a user and receive user input. In some embodiments, client computing device 121 may parse, classify, and otherwise process user input. For example, client computing device 121 may store user input associated with an agent claiming or selecting a lead, as will be described in detail below.

In some embodiments, client computing device 121 may be equipped with GPS location tracking and may transmit geolocation information via a wireless link and network 103. In some embodiments, negotiation server 120 and/or distributed chat application 135 may use the geolocation information to determine a geographic location associated with user 160. In some embodiments, negotiation server 120 may use signal transmitted by client computing device 121 to determine the geolocation of user 160 based on one or more of signal strength, GPS, cell tower triangulation, Wi-Fi location, or other input. In some embodiments, the geolocation associated with user 160 may be used by one or more computer program components associated with lending product recommendation engine 126 during lending product recommendation determination.

Network 140 includes, but is not limited to, any network or network system such as, but not limited to, a peer-to-peer network, a hybrid peer-to-peer network, a Local Area Network (“LAN”), a Wide Area Network (“WAN”), a public network, such as the Internet, a private network, a cellular network, a POTS network; any general network, communications network, or general network/communications network system; a wireless network; a wired network; a wireless and wired combination network; a satellite network; a cable network; a Virtual Private Network (“VPN”), a Mesh Network (or other many-to-many system); a cryptographic Directed Acyclic Graph (“crypto DAG”); any combination of different network types; or any other system capable of allowing communication between two or more computing systems, whether available or known at the time of filing or as later developed. Some common embodiments may typically comprise an “Internet Protocol” address system and a distributed ledger technology system using cryptographic addresses as end points, but the scope of the present disclosure is not restricted to such. A person of ordinary skill in the art having the benefit of the present disclosure would understand that an address system can be used on multiple network types; for example, Ethereum's DLT technology running Ropstein, Mainnet, Casper, Kovan, Rinkeby, Goerli and Rinkeby networks.

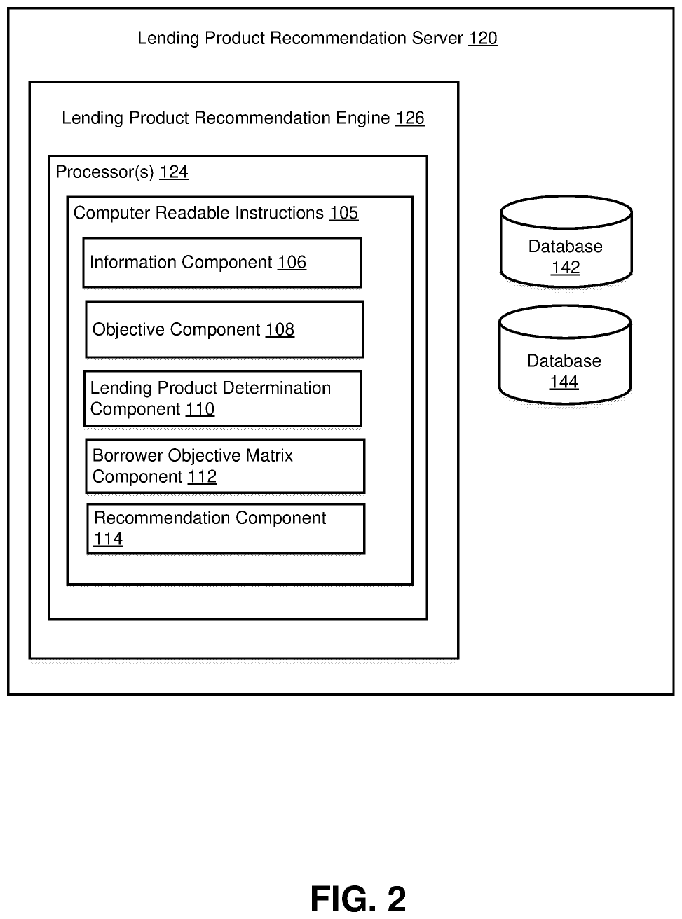

FIG. 2 illustrates an example lending product recommendation server 120 of system 100 illustrated in FIG. 1 configured in accordance with one embodiment. In some embodiments, the various below-described components of FIG. 2 may be used to determine lending product recommendations based on specific borrower circumstances, as described herein.

In some embodiments, lending product recommendation server 120 may include lending product recommendation engine 126, as alluded to above. In some embodiments, lending product recommendation engine 126 may be operable by one or more processor(s) 124 configured to execute one or more computer readable instructions 105 of one or more computer program components. In some embodiments, the computer program components may include one or more of a borrower information component 106, an objective component 108, a lending product determination component 110, a borrower objective matrix determination component 112, a recommendation component 114, and/or other such components.

In some embodiments, lending product recommendation server 120 may also include one or more databases. For example, databases 142 and 144 may be used to store data used by lending product recommendation engine 126. For example, database 142 may store borrower information received via client computing device 121. In some embodiments, database 144 may store lending product and historical lending information associated with other users of lending product recommendation system 100.

In other embodiments, database 144 may store lending product and historical claim information associated with users of third party partners associated with lending product recommendation system 100. For example, the third party partner utilizing system 100 may provide information related to lending product of their clients.

In some embodiments, borrower information component 106 may be configured to obtain information related to the borrower for which lending product is being sought. For example, borrower information component 106 may be configured to obtain information that is being provided by user input via client computing device 104.

In some embodiments, borrower information component 106, may be configured to use machine learning to determine one or more user preferences, e.g., preferences for lending product, cost, convenience, best value.

In some embodiments, borrower information component 106 may be configured to use one or more of a deep learning model, a logistic regression model, a Long Short Term Memory (LSTM) network, supervised or unsupervised model, etc. In some embodiments, borrower information component 106 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

In some embodiments, objective component 108 may be configured to determine one or more objective and the likelihood of each objective being satisfied based on the information provided by the user to borrower information component 106.

In some embodiments, objective component 108 may be configured to determine the objective and the likelihood of each objective being satisfied using a number of models or methods. For example, Bayesian-type statistical analysis may be used during the likelihood determination.

In some embodiments, objective component 108 may be configured to assign specificity, relevance, confidence, and/or weight to each borrower attribute used in determining objective and the likelihood of each objective being satisfied.

In some embodiments, a likelihood of objective and the likelihood of each objective being satisfied may be expressed as an incident score. For example, an incident score may be expressed on a sliding scale of percentage values (e.g. 10 percent, 15 percent, . . . n, where a percentage may reflect likelihood of conversion occurrence), numerical values (e.g., 1, 2, . . . n, where a number may be assigned as low and/or high), verbal levels (e.g., very low, low, medium, high, very high, and/or other verbal levels), and/or any other scheme to represent a confidence score.

In some embodiments, objective component 108, may be configured to utilize machine learning to determine the objective and the likelihood of each objective being satisfied based on user input. For example, in a training stage borrower objective component 108 (or other component) may be trained using training data or actual data in an objective determination context, and then at an inference stage can determine objective and the likelihood of each objective being satisfied. For example, the machine learning model can be trained using synthetic data, e.g., data that is automatically generated by a computer, with no use of user information.

In some embodiments, objective component 108 may be configured to use one or more of a deep learning model, a logistic regression model, a Long Short Term Memory (LSTM) network, supervised or unsupervised model, etc. In some embodiments, objective component 108 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

In some embodiments, lending product determination component 110 may be configured to determine one or more lending products relevant to the user's needs based on borrower classification determined by borrower information component 106 objective and the likelihood of each objective being satisfied determination made by objective component 108. In

In some embodiments, lending product component 110 may be configured to determine lending product limits or levels associated with each product that are the relevant to user's needs. For example, lending product limits may include a maximum interest rate or minimum monthly payment.

In some embodiments, when determining one or more relevant products and lending product limits, lending product component 110 may utilize the one or more personal preferences determined by borrower information component 106, as alluded to above.

In some embodiments, lending product component 110 may be configured to determine one or more relevant products and lending product limits, using a number of models or methods. For example, Bayesian-type statistical analysis may be used during the likelihood determination.

In some embodiments, lending product component 110, may be configured to use machine learning to determine one or more relevant products and lending product limits

In some embodiments, lender component 112 may be configured to determine a particular product associated with a particular lender based on particular product determinations by lending product component 110. For example, a particular lender may offer multiple policies, each policy including a number of products. By virtue of determining the product first, lender component 112 may select a policy that fits particular circumstances (i.e., based on lending product needs determined by lending product component 110, which are in turn based on borrower classification determined by borrower information component 106 objective and the likelihood of each objective being satisfied determination made by objective component 108, as alluded to above).

In some embodiments, lender component 112 may be configured to determine multiple products associated with one or more lenders. For example, lender component 112 may be configured to assign a preference to a particular product determination by indicating that this product(s) is preferred or recommended. In yet other embodiments, lender component 112 may be configured to provide a recommendation explanation detailing reasons why one product is preferred over another, as described in further detail below.

In some embodiments, different lenders may be determined based on lender performance factors. For example, lender performance factors may include lender's claim handling rate, reputation, financial stability, or third-party ratings may be used by lender component 112. In some embodiments, lender component 112 may be configured to assign specificity, relevance, confidence, and/or weight to different products and different lending product limits offered by each lender as well as each lender performance factor, described above, during lender determination.

In some embodiments, recommendation component 114 may be configured to generate one or more recommendations based on product and lending product limits determined by lending product component 110. For example, individual lending product recommendations may be generated based on one or more relevant products and lending product limits determinations made by lending product component 110 may be configured.

In some embodiments, the recommendations may include one or more reasons associated with a lending product recommendation. For example, a lending product recommendation reason may include an explanation a particular lending product is applicable to borrowers circumstances.

In some embodiments, recommendation component 114 may be configured to generate a default lending product recommendation reason.

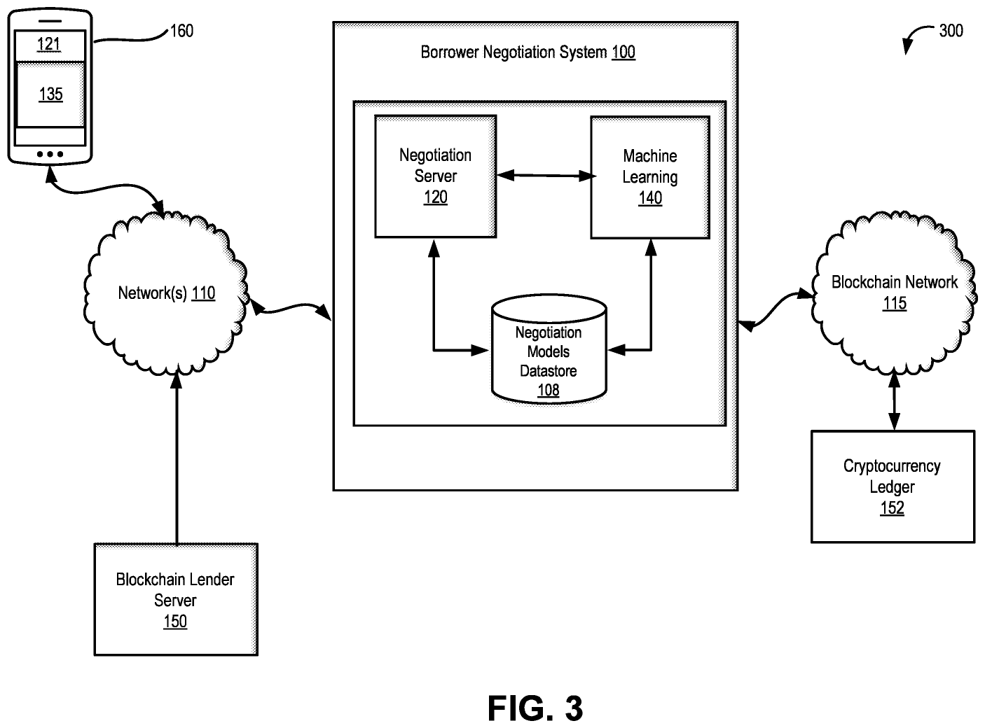

FIG. 3 illustrates an example environment 300 for providing a conversation interface assisted by (AA) for enabling real-estate market transactions via a distributed ledger network, in accordance with the embodiments disclosed herein. This diagram illustrates an example environment 300 that may include a borrower negotiation system 100, a client computing device 121, a network 110, a blockchain network 115, and a cryptocurrency ledger 152. The client computing device 121 may be in communication with borrower negotiation system 100 via the network 140. The borrower negotiation system 100 may include a negotiation server 120, a machine-learning server 140, and a negotiation models datastore 108.

In some embodiments, negotiation server 120 may include a machine-learning component configured to determine lending terms more likely to result in a favorable outcome for a particular borrower based on individual borrower's characteristics and needs. For example, one borrower may benefit from lower interest rates while another borrower is more interested in lower monthly payment.

In some embodiments, borrowers and lenders may use natural language commands when participating in the real-estate market transactions via a distributed ledger network assisted by an automated software assistant (AA). In some embodiments, the various below-described components of borrower negotiation system 100 may be used to initiate a client AA-enabled negotiation application 135 (i.e., a distributed application running on client computing device) within client computing device 121. For example, client AA-enabled negotiation application 135 may comprise a chat interface and may be configured to enable sellers and buyers perform real-estate related transactions enabled by negotiation server 120 of system 100. For example, a buyer can place offers via guaranteed preapproval tokens and receive information on the number of pending offers associated with the real-estate property. Similarly, a seller can accept buyer's offer and receive information on the number of any pending offers that buyer may have associated with a preapproval token. A user 160 (e.g., a borrower) may be associated with a client computing device 121. In some embodiments, the AA-enabled negotiation application 135 may be configured to operate like a crypto wallet application.

In some embodiments, AA may be configured to use one or more of a deep learning model, a logistic regression model, a Long Short Term Memory (LSTM) network, supervised or unsupervised model, etc. In some embodiments, AA may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

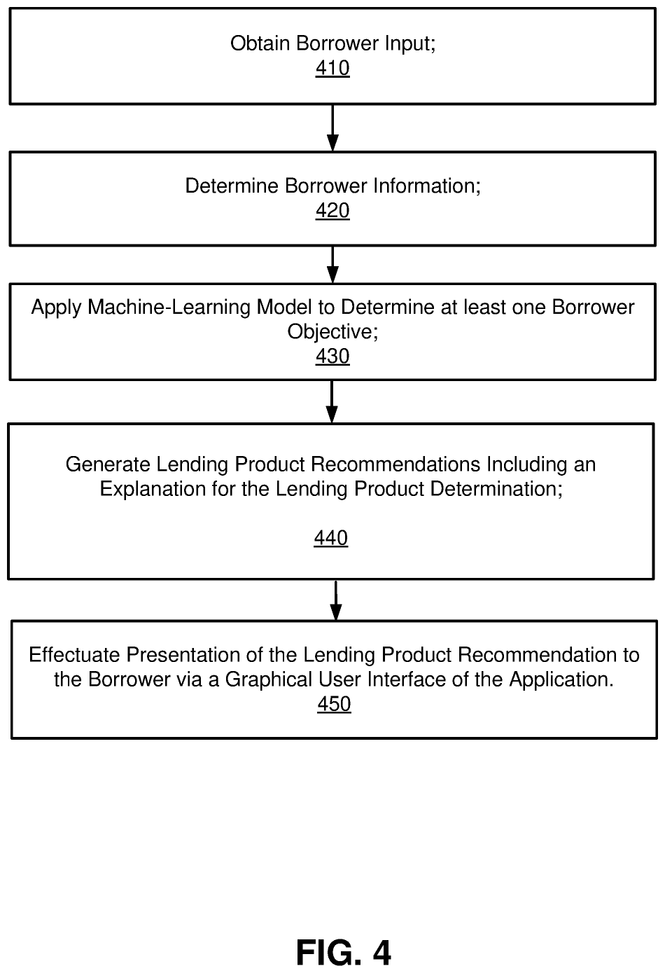

FIG. 4 illustrates a flow diagram describing a method for generating lending product recommendation based on the information provided by the borrower, in accordance with one embodiment. In some embodiments, method 400 can be implemented, for example, on a server system, e.g., lending product recommendation server 120, as illustrated in FIGS. 1-2.

At operation 410, lending product recommendation engine 126 obtains borrower input.

At operation 420, lending product recommendation engine 126 determines borrower information. For example, the information related to the borrower's income, employment, property, risk factors, future plans, and other relevant data. At operation 430, information component 106 determines borrower objectives based on information in step 410.

At operation 454, recommendation component 114 generates one or more lending product recommendations based on borrower objectives determined in step 430. At operation 450, recommendation component 114 effectuates the presentation of the one or more lending product recommendations.

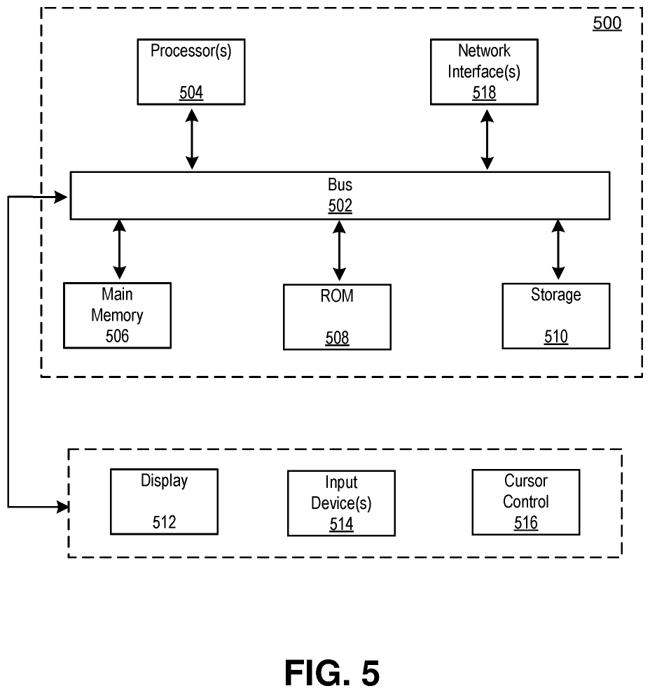

FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 505, such as a random access memory (RAM), cache and/or other dynamic storage devices, coupled to bus 502 for storing information and instructions to be executed by processor 504. Main memory 505 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, Javascript, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 505. Such instructions may be read into main memory 505 from another storage medium, such as storage device 510. Execution of the sequences of instructions contained in main memory 505 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 505. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method for assisting a borrower in a negotiation with a lender, the method comprising:
receiving borrower input within a conversation interface of an application;
converting the borrower input into a machine readable format;
identifying borrower information from the borrower input;
applying a first machine-learning model to the borrower input to determine at least one borrower objective;
generating a lending product recommendation including an explanation for the lending product determination; and
effectuating presentation of the lending product recommendation to the borrower via a graphical user interface of the application.

2. The method of claim 1, wherein the borrower input comprises at least one communication mode including voice, text, and video with voice.

3. The method of claim 1, further comprising modifying a borrower model based on the borrower input and the at least one borrower objective.

4. The method of claim 3, further comprising modifying a current lender model based on the borrower input and the at least one borrower objective, the borrower model, and the lender model.

5. The method of claim 4, further comprising conducting a negotiation with the lender based on a second machine-learning model applied to the current lender model and a borrower objective matrix, wherein the borrower objective matrix is informed by the valuations of the borrower input and the by the and lender input.

6. The method of claim 5, wherein the negotiation comprises generating a set of responses for the lender.

7. The method of claim 6, further comprising:
presenting the set of offers to the borrower in context of a negotiation with the lender.

8. A system comprising:
a processor configured for:
receiving borrower input within a conversation interface of an application;
converting the borrower input into a machine readable format;
identifying borrower information from the borrower input;
applying a first machine-learning model to the borrower input to determine at least one borrower objective;
generating a lending product recommendation including an explanation for the lending product determination; and
effectuating presentation of the lending product recommendation to the borrower via a graphical user interface of the application.

9. The system of claim 8, wherein the borrower input comprises at least one communication mode including voice, text, and video with voice.

10. The system of claim 9, further comprising modifying a borrower model based on the borrower input and the at least one borrower objective.

11. The system of claim 10, further comprising modifying a current lender model based on the borrower input and the at least one borrower objective, the borrower model, and the lender model.

12. The method of claim 11, further comprising conducting a negotiation with the lender based on a second machine-learning model applied to the current lender model and a objective matrix, wherein the objective matrix is informed by the valuations of the borrower input and the by the and lender input.

13. The system of claim 12, wherein the negotiation comprises generating a set of responses for the lender.
